(19) United States
(12) Patent Application Publication
(10) Pub. No.: US 2015/0084966 A1
(43) Pub. Date: Mar. 26, 2015

(54) FONT RENDERING SYSTEM AND METHOD

(71) Applicant: Kobo Inc., Toronto (CA)

(72) Inventors: Ryan Sood, Toronto (CA); Damian Lewis, Toronto (CA)

(73) Assignee: Kobo Inc., Toronto (CA)

(21) Appl. No.: 14/033,766

(22) Filed: Sep. 23, 2013

(51) Int. Cl. G06T 11/20; G06F 17/21

(52) U.S. Cl. CPC G06T 11/203; G06F 17/214
USPC 345/467

(57) ABSTRACT

Examples described herein include a computing device that enables users to provide input to affect a particular manner in which a particular font is displayed. In particular, the user input can after a line weight and/or sharpness of a selected font.

### TECHNICAL FIELD

Examples described herein provide for a font rendering system and method.

### BACKGROUND

With popularity of e-readers, tablets and mobile computing devices, font rendering techniques are increasingly in need to display text content. Font rendering engines are programs that utilize font libraries in order to display text content in a variety of typefaces. Developing clarity and sharpness in the manner text content is rendered can be challenging, given the different types of devices (e.g., small screen phones), displays (e.g., LCD or E-paper) and languages in use (e.g., Latin alphabet or Asian scripts). Font rendering engines typically employ edge hinting or edge rendering processes to enhance the appearance of text content, so as to create crisp and consistent characters for display.

### BRIEF DESCRIPTION OF THE DRAWINGS

FIG. 1 illustrates a system for operating a computing device, according to an embodiment.

FIG. 2 illustrates an example of a mobile computing device, according to an embodiment.

FIG. 3 illustrates a font rendering system, according to one or more embodiments.

FIG. 4 illustrates an example method for displaying text content on a computing device, according to an embodiment.

FIG. 5 illustrates an example of a font interface for enabling a user to adjust font values for parameters such as sharpness or weight, so as to affect an overall appearance of a selected font.

### DETAILED DESCRIPTION

Examples described herein include a computing device that enables users to provide input to affect a manner in which a particular font is displayed. In particular, the user input can after a line weight and/or sharpness of a selected font.

Among other benefits, examples described herein recognize that users can have different preferences and needs for how font rendering engines display text. For example, a font rendering engine can employ edge rendering or edge hinting and anti-aliasing processes to enhance clarity and viewability of how a particular font is rendered. Such processes often deploy default settings with regard to parameter such as line weight and sharpness, and the output of these processes reflects such default settings. Embodiments described herein recognize that the user's selection of the font type, the type of script (e.g., Asian versus Latin) or the device on which the user operates are factors which can affect how a particular font is rendered, particularly as to parameters such as sharpness and line weight.

In an embodiment, an interface is displayed on a computing device. The interface can include a feature for enabling a user to specify input to adjust a value that affects sharpness for a selected font. The computing device receives input from the user interacting with the first feature. In response, the computing device displays text with the selected font, with the sharpness of the selected font being adjusted based on the user input. The value of the sharpness can be adjusted without changing any of (i) the font that is selected, (ii) a size of the selected font, or (iii) a line weight of the selected font.

In another embodiment, the interface can include a feature for enabling a user to specify input to adjust a value that affects a line weight of the selected font. The computing device receives input from the user interacting with the first feature. In response, the computing device displays text with the selected font, with the line weight of the selected font being adjusted based on the user input. The value of the line weight can be adjusted without changing either of the font that is selected, or a size of the selected font.

Still further, the computing device can display an interface that includes a first feature for enabling a user to specify input to adjust a value that affects a sharpness for a selected font, and a second feature for enabling the user to specify input to adjust a value that affects a line weight for the selected font. The computing device receives input from the user interacting with the first feature and with the second feature, and displays text with the selected font. The computing device is able to adjust the sharpness and the line weight of the selected font based on the values provided with the first feature and with the second feature. The sharpness and line weight can be adjusted without changing either the font that is selected, or a size of the selected font.

Additionally, embodiments recognize that users can have personal preferences as to how text content should appear, beyond that of font selection (or font size selection). In particular, embodiments recognize that users often have personal preferences as to line weight and sharpness when viewing text content in a particular font setting.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

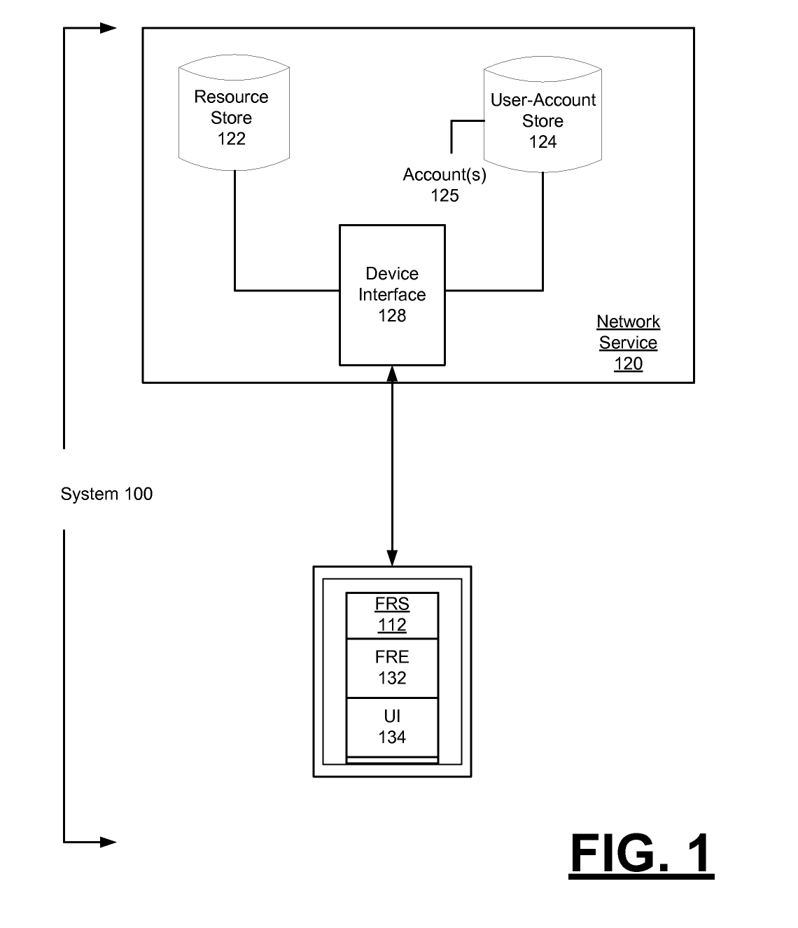

FIG. 1 illustrates a system for operating a computing device, according to an embodiment. A system 100 includes a mobile computing device 110 and a network service 120. The network service 120 may include multiple servers and other computing resources that provide various services, including services in which digital content items (e.g., e-books) are sold, shared, downloaded and/or stored. According to embodiments, the mobile computing device 110 includes enhanced text rendering functionality, including programmatic resources to enable users to adjust settings that affect sharpness and line weight in the manner that the font is rendered. More generally, the mobile computing device 110 can correspond to any computing device that can process input and provide output. For example, the mobile computing device 110 can correspond to a tablet, telephony/messaging device (e.g., smart phone) or portable computing device. The mobile computing device 110 can run an operating system on which multiple applications are installed, including one or more applications that links the device to the network service 120. The application(s) can receive services and other functionality from the network service. Additionally, one or more applications on the mobile computing device can correspond to text-rendering applications, such as an e-reader application.

In some implementations, the mobile computing device 110 is equipped with hardware and software to optimize activities received from the network service 120 (e.g., reading electronic content, including e-books). The mobile computing device 110 can have a tablet like form factor, although variations are possible. In some cases, the mobile computing device 110 can also have an E-ink display or a touchscreen display.

The network service 120 can include a device interface 128, which communicates with individual devices that access the service. Among other resources, the network service 120 can include a resource store 122 and a user account store 124. The user account store 124 can associate mobile computing device 110 with a user and an account 125. The account 125 can also be associated with resources (e.g., digital content items such as e-books) of the resource store 122. As described further, the user account store 124 can retain metadata for individual accounts 125 to identify resources (e.g., digital content items or e-books) that have been purchased or made available for consumption for a given account. The mobile computing device 110 may be associated with the user account 125, and multiple devices may be associated with the same account.

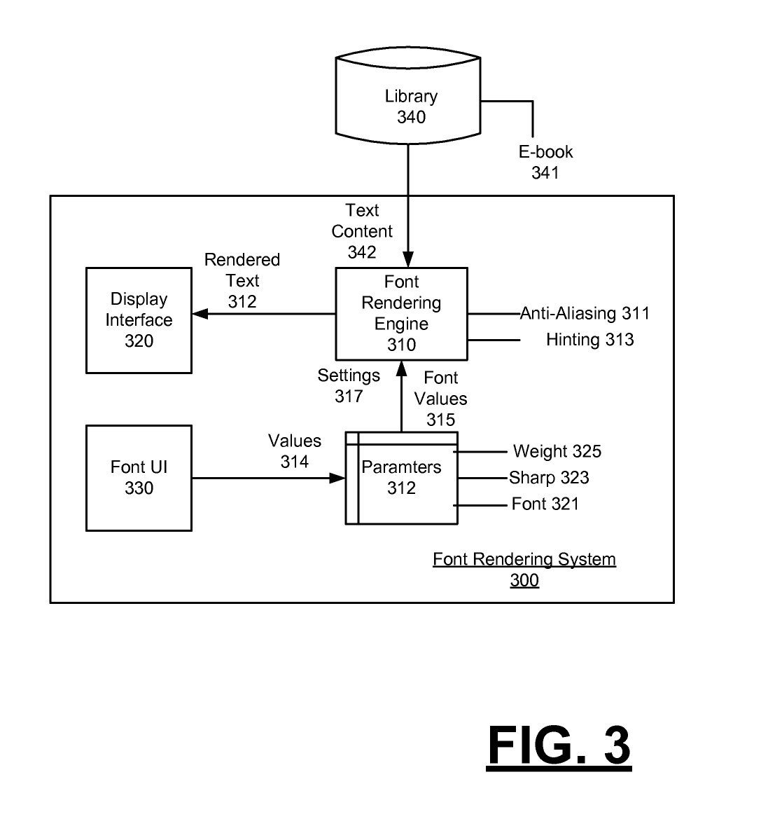

In some embodiments, the mobile computing device 110 includes features to enhance or optimize the rendering of text content. For example, the mobile computing device 110 can operate as an e-reader that renders e-books. To enhance text rendering experience for the user, the mobile computing device 110 includes a font rendering system 112 that includes a font rendering engine 132 and a user interface 134. The user interface 134 enables the user to set one or more parameters for how a selected font is rendered. For example, the user interface 134 enables the user to provide parameters that tune sharpness and line weight. These parameters in particular can affect edge hinting and/or anti-aliasing processes of the font rendering engine 132. Specific examples provide that the user can set values for the sharpness and/or line weight of how text is rendered in a selected font. An example of font rendering system 112 is shown with FIG. 3.

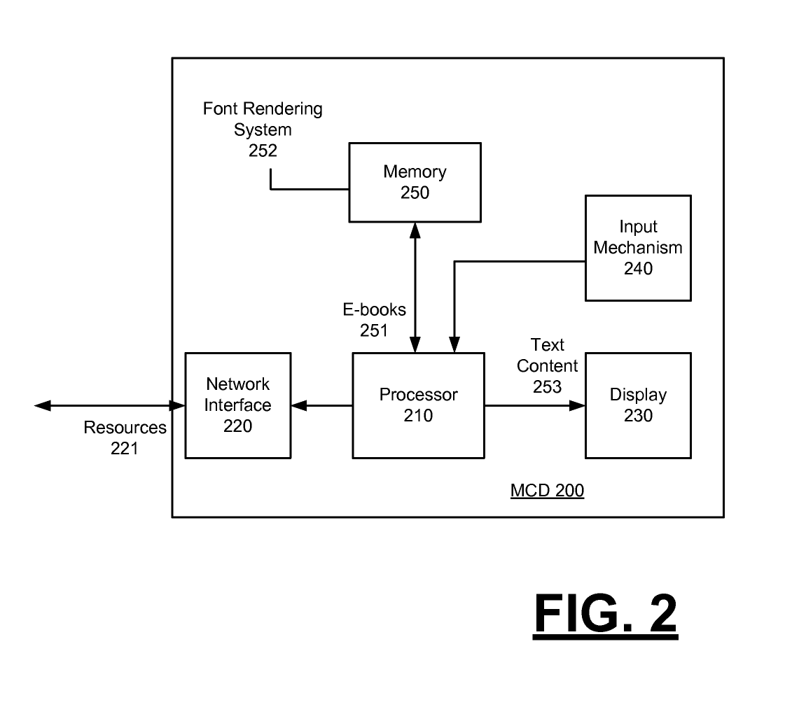

FIG. 2 illustrates an example of a mobile computing device, according to an embodiment. A mobile computing device 200 as described with an example of FIG. 2 can be used to implement a system such as described with FIG. 1. The mobile computing device 200 can include a processor 210, a network interface 220, a display 230, one or more input mechanisms 240, and a memory 250. The processor 210 can utilize the network interface 220 to communicate with a network service 120 (see FIG. 1). In communicating with the network service 120, the mobile computing device 110 can receive resources 221, such as digital content items, that the user has purchased or otherwise selected to download from the network service 120. The resources 221 that are downloaded onto the mobile computing device 200 may be stored in the memory 250.

The display 230 can correspond to, for example, a liquid crystal display (LCD) that illuminates in order to provide content generated from processor 210. In alternative variations, for example, the display 230 can correspond to an electronic paper type display, which can be designed to mimic conventional paper in the manner in which they display content. Examples of such display technologies include electrophoretic displays, electrowetting displays, and electrofluidic displays. Examples described herein further appreciate that the media in which electronic type displays are provided can vary, and include, for example, plastic or paper combined with transistor elements or other circuitry.

The memory 250 stores instructions for implementing a font rendering system 252. An example of the font rendering system 252 is provided with FIG. 2. The processor 210 can retrieve e-books 251 from the memory 250, and generates text content 253 corresponding to the e-book on the display 230. The processor 210 uses instructions for the font rendering system 252 to enhance the appearance of text content 253 on display 230. In particular, the text content 253 can be enhanced based on user-specified parameters corresponding to, for example, line weight and sharpness for a selected font.

FIG. 3 illustrates a font rendering system, according to one or more embodiments. A font rendering system 300 as shown with an example of FIG. 3 can be implemented on, for example, a mobile computing device such as shown with an example of FIG. 1 or FIG. 2. The font rendering system 300 includes a font rendering engine 310, a display interface 320, and a font user interface (UI) 330. The font rendering system 300 can cooperate with a library 340 in order to render text content 342 using a selected font. An output of the font rendering engine 310 can include rendered text 319, which can be output onto the display interface 320.

According to some embodiments, the font rendering system 300 provides font UI 330 in order to enable a user to select parameters for rendering text 319. The font rendering engine 310 can utilize a set of parameters 312, which provide font values 315 and settings 317 (e.g., selected font) for processes that tune the appearance of the rendered text 319. In particular, the font rendering engine 310 can implement anti-aliasing and hinting processes 311, 313 which affect an appearance of the rendered text. As described below, the font values 315 can adjust values such as sharpness and line weight, which affect implementation of, for example, the anti-aliasing and hinting processes 311, 313. The result is that the appearance of the rendered text 319 can be tuned based on adjustments to the font values 315.

In more detail, the font values 315 can be based on a set of parameters 312 that include (i) the sharpness 323 of the selected font, and (ii) the line weight 325 of the select font. The font values 315 can include default values (e.g., provided by manufacturer). The font UI 330 can enable the user to specify values 314 that adjust or change the value of the parameters 312, so as to change or adjust font values 315. Among other aspects, the change in the font values 315 can after the output of the anti-aliasing and hinting processes 311, 313, without affecting the selection or size of the font in use. In this way, the rendered text 319 can be adjusted or tuned based on values 314 to parameters for sharpness 323 and line weight 325, specified through the font UI 330.

According to some embodiments, the font rendering engine 310 can be provided as a modular programmatic component. The font rendering system 300 can include functionality or components for exposing programmatic interfaces of the font rendering engine 310. In one embodiment, the font UI 330 can signal the values 314 to the programmatic interfaces of the font rendering engine 310 based on user input.

Methodology

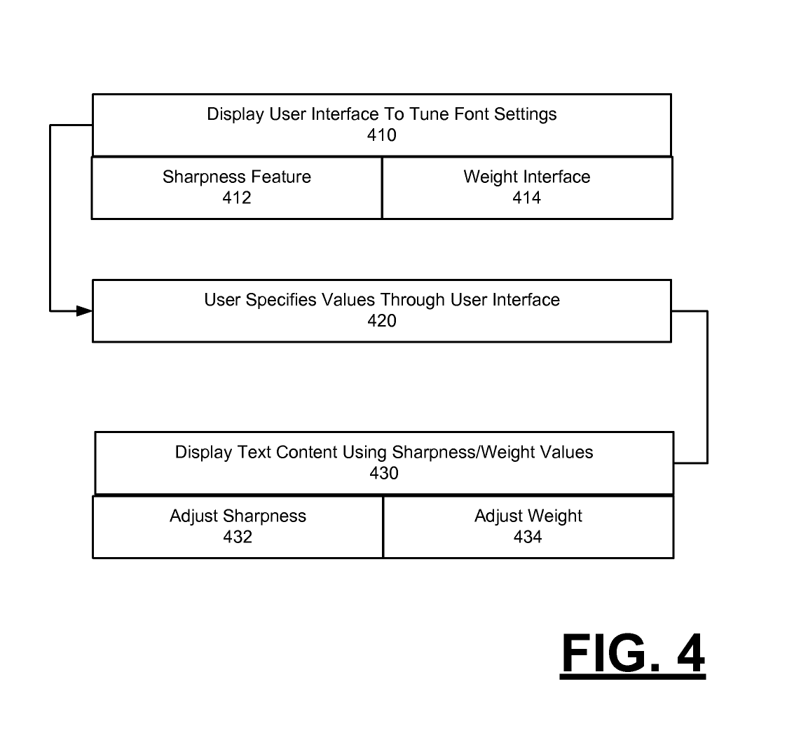

FIG. 4 illustrates an example method for displaying text content on a computing device, according to an embodiment. A method such as described with examples of FIG. 4 may be implemented using components such as described with FIG. 3. Accordingly, reference may be made to elements of FIG. 3 for purpose of illustrating suitable elements or components for performing a step or sub-step being described.

With reference to FIG. 4, a user interface is provided on the computing device in connection with text content (e.g., e-book) that is displayed or otherwise provided on the computing device (410). In particular, the computing device includes features to tune one or more font settings of text content that is displayed by the computing device. In one implementation, the font UI 330 can include a sharpness feature to enable the user to enter input that affects a sharpness of the selected font in the displayed text content (412). The font UI 330 can also include a line weight feature to enable the user to enter input that affects a line weight of the font in the displayed text content (414).

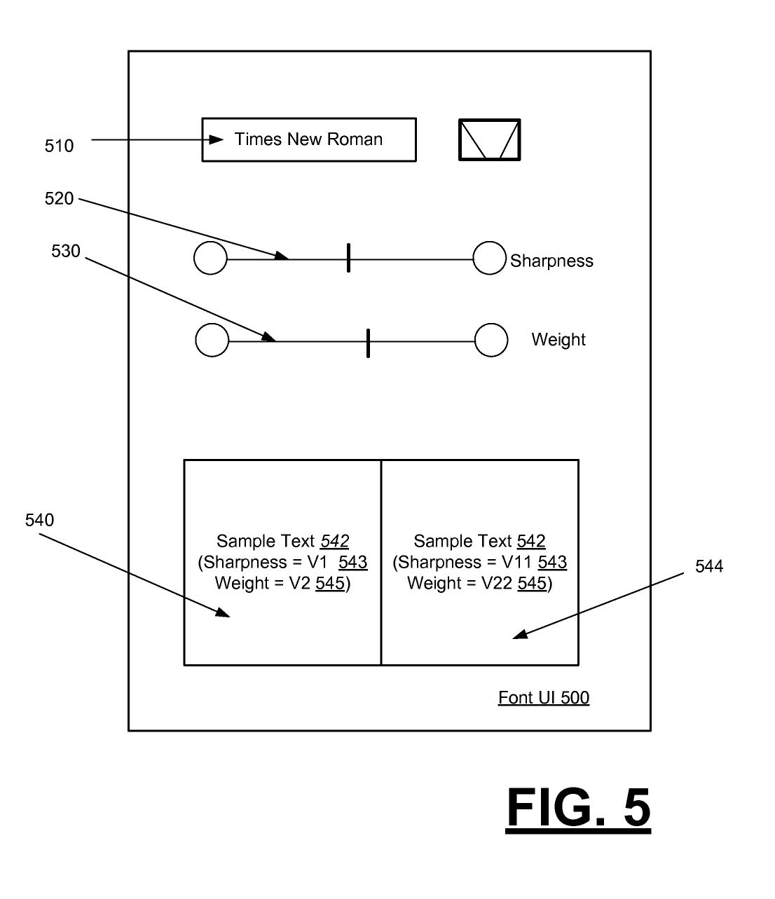

A user can operate the user interface to access the sharpness and/or line weight features and to specify values for adjusting the characteristics of the font in the displayed text (420). An example of the user interface is displayed with an example of FIG. 5. The font UI 330, for example, can be provided to the user on request while the user is viewing text content. The viewer can, for example, operate the font UI 330 to specify values or settings for a variety of font parameters, including font selection, sharpness, and line weight.

Upon receiving user input, the computing device responds by altering the appearance of the text content (430). In particular, changes to values for sharpness (432) and line weight (434) can tune or refine an overall appearance of a particular font. The adjustment made to sharpness and line weight can be made without affecting settings of the font. For example, refinements to sharpness or line weight can be made without changing either the actual font that is selected, or the size of the selected font.

FIG. 5 illustrates an example of a font interface for enabling a user to adjust font values for parameters such as sharpness or line weight, so as to affect an overall appearance of a selected font. A mobile computing device such as described with FIG. 1 or FIG. 2 can be used to render a font UI 500 as shown with an example of FIG. 5. Furthermore, the font UI 500 can be provided as a component of the font rendering system 300, as described with an example of FIG. 3. The font UI 500 can be rendered on a display 230 (see FIG. 2) in order to prompt for user input.

With reference to FIG. 5, the font UI 500 includes a font selection feature 510, a sharpness feature 520, and a line weight feature 530. The font UI 500 can be provided in conjunction with text content displayed on the computing device. For example, the font UI 500 can be displayed as a feature of an e-reader. In particular, the user may select to view and operate the font UI 500 when viewing an e-book.

In an example of FIG. 5, the font selection feature 510 enables the user to select a font for displaying text content (e.g., e-book). For example, an e-book may be displayed under a default font (e.g., Times New Roman), and the user can use the font selection feature 510 to change the selected font (e.g., Georgia).

The sharpness feature 520 enables the user to specify a value for a sharpness of the selected font. Likewise, the line weight feature 530 enables the user to specify a value for a line weight of the selected font. Each of the sharpness feature 520 and the line weight feature 530 can provide a range of possible values from which the user can adjust or select a specific value. For example, in an implementation such as shown, each of the sharpness feature 520 and the line weight feature 530 can be provided in the form of a slider, which can be manipulated linearly between a minimum and maximum value. In this way, the user can select or tune values for sharpness and line weight across a continuum of possible values.

In an embodiment, the font UI 500 includes features for providing the user with feedback as to selections made through the interface. The feedback enables the user to view how the change in values to the selected font after the appearance of the text, without the computing device having to after the font rendering of the entire content item (e.g., e-book).

In particular, the font UI 500 includes (i) a first window 540 which displays sample text 542 using font values that precede the user's input (e.g., adjustment to font selection, sharpness or line weight), and (ii) a second window 544 which displays the sample text 542 using font values that are based on the user's input and adjustment (e.g., adjustment to font selection, sharpness or line weight). The sample text can be generated using different instances or outputs of the font rendering engine 310 in use on the computing device. In one implementation, the first window 540 displays sample text 542 using parameters for sharpness and line weight 543, 545 that are set to respective values (V1, V2). The sample text 542 in the first window 540 can thus be displayed through the font rendering engine 310 using the first set of values. The second window 544 can also display sample text 542 using the font rendering engine 310, except the font values 315 are altered based on user input as provided by user interaction with one of the sharpness feature 520 or line weight feature 530. Thus, the second window 544 outputs the sample text from the rendering engine, using font parameters for sharpness and line weight 543, 545 that are set to respective values (V11, V22) as provided by user input and adjustment.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for displaying text on a computing device, the method being implemented by one or more processors of the computing device and comprising:
displaying an interface, including a first feature for enabling a user to specify input to adjust a value that affects a sharpness for a selected font;
receiving the input from the user interacting with the first feature; and
displaying text with the selected font, wherein displaying the text includes adjusting the sharpness of the selected font based on the adjusted value, without changing any of (i) the font that is selected, (ii) a size of the selected font, or (iii) a line weight of the selected font.

2. The method of claim 1, further comprising providing on the interface a sample text that shows a change in the sharpness of the selected font based on the adjusted value as compared to a value of the sharpness of the selected font preceding the input.

3. The method of claim 2, wherein providing the sample text includes displaying (i) a first rendering of the sample text with the sharpness being based on the value preceding the input, and (ii) a second rendering of the sample text with the sharpness being based on the selected value from the input.

4. The method of claim 1, wherein displaying the interface includes displaying a second feature for enabling the user to specify a value from a range of possible values for the line weight of the selected font, and wherein displaying the text includes adjusting the line weight of the selected font based on a value selected by the user operating the second feature.

5. The method of claim 4, further comprising:
providing on the interface a sample text that shows a change in the selected font based on (i) an adjustment to the sharpness based on the selected value from input specified through the first feature, (ii) an adjustment to the line weight based on the selected value from input specified through the second feature.

6. The method of claim 4, wherein providing the sample text includes displaying (i) a first rendering of the sample text with the sharpness and the line weight being based on respective values that precede the input, and (ii) a second rendering of the sample text with the sharpness and the line weight being based on the respective values after the input.

7. The method of claim 1, wherein displaying the text includes displaying an e-book.

8. The method of claim 1, wherein displaying the interface includes enabling the use to select a value for the sharpness from a range of possible values.

9. A method for displaying text on a computing device, the method being implemented by one or more processors of the computing device and comprising:
displaying an interface, including a first feature for enabling a user to specify input to adjust a value that affects a line weight for a selected font;
receiving the input from the user interacting with the first feature; and
displaying text with the selected font, wherein displaying the text includes adjusting the line weight of the selected font based on the adjusted, without changing any of (i) the font that is selected, or (ii) a size of the selected font.

10. The method of claim 9, further comprising providing on the interface a sample text that shows a change in the line weight of the selected font based on the selected value as compared to a value of the line weight of the selected font preceding the input.

11. The method of claim 10, wherein providing the sample text includes displaying (i) a first rendering of the sample text with the line weight being based on the value preceding the input, and (ii) a second rendering of the sample text with the line weight being based on the selected value from the input.

12. The method of claim 9, wherein displaying the interface includes displaying a second feature for enabling the user to specify a value from a range of possible values for the sharpness of the selected font, and wherein displaying the text includes adjusting the sharpness of the selected font based on a value selected by the user operating the second feature.

13. The method of claim 12, further comprising:
providing on the interface a sample text that shows a change in the selected font based on (i) an adjustment to the line weight based on the value specified with the first feature, and (ii) an adjustment to the sharpness based on the value specified with the second feature.

14. The method of claim 9, wherein displaying the text includes displaying an e-book.

15. The method of claim 9, wherein displaying the interface includes enabling the use to select a value for the sharpness from a range of possible values.

16. A computing device comprising:
a memory, the memory storing a set of instructions;
a processor that uses the instructions stored in memory to:
display an interface, including a first feature for enabling a user to specify input to adjust a value that affects a sharpness for a selected font, and a second feature for enabling the user to specify input to adjust a value that affects a line weight for the selected font;
receive the input from the user interacting with the first feature and with the second feature; and
display text with the selected font, wherein displaying the text includes adjusting the sharpness and the line weight of the selected font based on the adjusted values provided with the first feature and with the second feature, without changing any of (i) the font that is selected, and (ii) a size of the selected font.

17. The computing device of claim 16, wherein the one or more processors display, through the interface, a sample text that shows a change in the sharpness and the line weight of the selected font based on the selected values specified by the input as compared to values of the sharpness and the line weight of the selected font preceding the input.

18. The computing device of claim 17, wherein the one or more processors display the sample text by displaying (i) a first rendering of the sample text with the values of the sharpness and the line weight preceding the input, and (ii) a second rendering of the sample text with the values of the sharpness and the line weight being based on the selected values from the input.

19. The computing device of claim 16, wherein the one or more processors display text corresponding to at least a portion of an e-book with the selected font.

20. The computing device of claim 16, wherein the one or more processors enable the user to change a font through the interface.
